(19) United States
(12) Patent Application Publication
(10) Pub. No.: US 2018/0313437 A1
(43) Pub. Date: Nov. 1, 2018

(54) SCREW DRIVE WITH AT LEAST ONE BEARING AS PLANET

(71) Applicant: Rene Semmelrath, Pischelsdorf Am Kulm (AT)

(72) Inventor: Rene SEMMELRATH, Pischelsdorf Am Kulm (AT)

(21) Appl. No.: 15/768,529

(22) PCT Filed: Aug. 24, 2016
(86) PCT No.: PCT/EP2016/070000

§ 371 Date: Apr. 13, 2018

(30) Foreign Application Priority Data
Oct. 15, 2015 (AT) A 50876/2015

(51) Int. Cl. F16H 25/22

(52) U.S. Cl. CPC F16H 25/2247; F16H 2025/228

(57) ABSTRACT

The present disclosure relates to a screw drive with an element having a thread, at least one planet and a holder, wherein the at least one planet is held by the holder and rolls along the threads of the thread of the element and the holder moves linearly along the thread of the element relative to the element. The at least one planet of the screw drive is formed by a bearing which engages with its outer ring or with its inner ring in the thread of the element via an angular section.

### BACKGROUND OF THE INVENTION

The present disclosure relates to a screw drive with an element having a thread, at least one planet and a holder, the at least one planet held by the holder rolling along the threads of the thread of the element and the holder moving linearly along the thread of the element relative to the element.

The skilled person is familiar with roller screws in which rollers in a cage roll around a threaded spindle on the thread of a threaded spindle. The rollers have a thread adapted to the thread of the threaded spindle and are axially supported in the cage that forms a support. The rollers thus form planets that circle around the threaded spindle, whereby the holder is transported linearly along the threaded spindle.

The skilled person is also familiar with ball screws, where balls are held in the recesses of a screw shaft by a holder around the screw shaft. The holder also features a ball recirculation system which, depending on the linear transport direction of the holder, allows the balls to be fed back into the recesses of the thread in the direction of transport from the rear to the front. The balls thus form planets that circle around the threaded spindle, whereby the holder is transported linearly along the threaded spindle.

The disadvantage of these two well-known screw drives is that the balls and the rollers roll directly in the thread of the threaded spindle, which is why both the thread of the threaded spindle and the thread in the rollers have to be manufactured very precisely and wear-resistant. This means that screw drives are relatively expensive compared to other linear drives. In practice, it has also been shown that soiling of the threaded spindle can lead to a hooked linear transport of the holder or even lead to a blockade of the entire screw drive.

### SUMMARY OF THE INVENTION

The present disclosure provides a screw drive that can be manufactured in a simple and cost-efficient way with a long service life.

The present disclosure proposes the use of a bearing which, with its outer ring or its inner ring, engages in the thread of the element via an angle section.

An advantage of this is that the actual rolling or rolling process does not take place in the thread of the element but in the bearings. As a result, it is possible to use bearings that are available at low cost and have a long service life. The webs and grooves of the inner rings or the outer rings of the bearings also run in the thread of the element in order to effect linear propulsion, but the actual unrolling process takes place in the bearings.

In this context, the element is particularly considered to be a threaded spindle or a hollow cylinder with an internal thread.

According to the present disclosure, three fundamentally different versions are to be distinguished. The one where the outer rings of the bearings engage in the thread of a threaded spindle. Although this first version is somewhat larger in size than the length of the holder or the circumference of the entire screw drive, the planets and the holder holding the planets together can be built very short, which is why the screw shaft only needs to be slightly longer than the transport distance that can be transported linearly.

In the second version, the inner rings engage in the thread of a threaded spindle, whereby the curvature of the inner rings clings to the curvature of the threaded spindle. As a result, the diameter of the bearings or the diameter of the holder holding the at least two bearings together is only slightly larger than the diameter of the threaded spindle, which is particularly advantageous in certain applications. This also means that the grooves or webs of the inner rings of the bearings engage in the thread of the threaded spindle via a relatively large angular section and can thus absorb relatively high carrying forces in the transport direction or in the opposite direction of transport.

In the third version, the outer rings engage in the thread of a hollow cylinder with an internal thread, whereby the curvature of the outer rings clings to the curvature of the hollow cylinder. Due to the arrangement of the bearings in the hollow cylinder, the outer diameter of the hollow cylinder forms the widest point of the thread drive. Furthermore, as with the second version, this design variant also allows the grooves or webs of the outer rings of the bearings to engage in the thread of the hollow cylinder via a relatively large angular section and thus absorb relatively high carrying forces in the direction of transport or in the opposite direction of transport.

Further advantageous designs of the thread drive in accordance with the invention are explained in more detail below on the basis of the figures.

### BRIEF DESCRIPTION OF THE DRAWINGS

FIG. 1 shows a lateral view of a screw drive with three ball bearings which engage with their outer rings in the thread of a screw spindle.

FIG. 2 shows a plan view of the screw drive according to FIG. 1.

FIG. 3 shows a sectional drawing of a side view of a screw drive with two groups of two ball bearings per group, with the four ball bearings and their outer rings engaging in the thread of the screw shaft.

FIG. 4 shows a sectional drawing of a side view of a screw drive with two ball bearings, which engage with their inner rings in the thread of the screw shaft.

FIG. 5 shows a plan view of the screw drive according to FIG. 4.

FIG. 6 shows a sectional drawing of a lateral view of a screw drive with two ball bearings, which engage with their outer rings in the internal thread of a hollow cylinder.

FIG. 7 shows a plan view of the screw drive according to FIG. 6.

### DETAILED DESCRIPTION

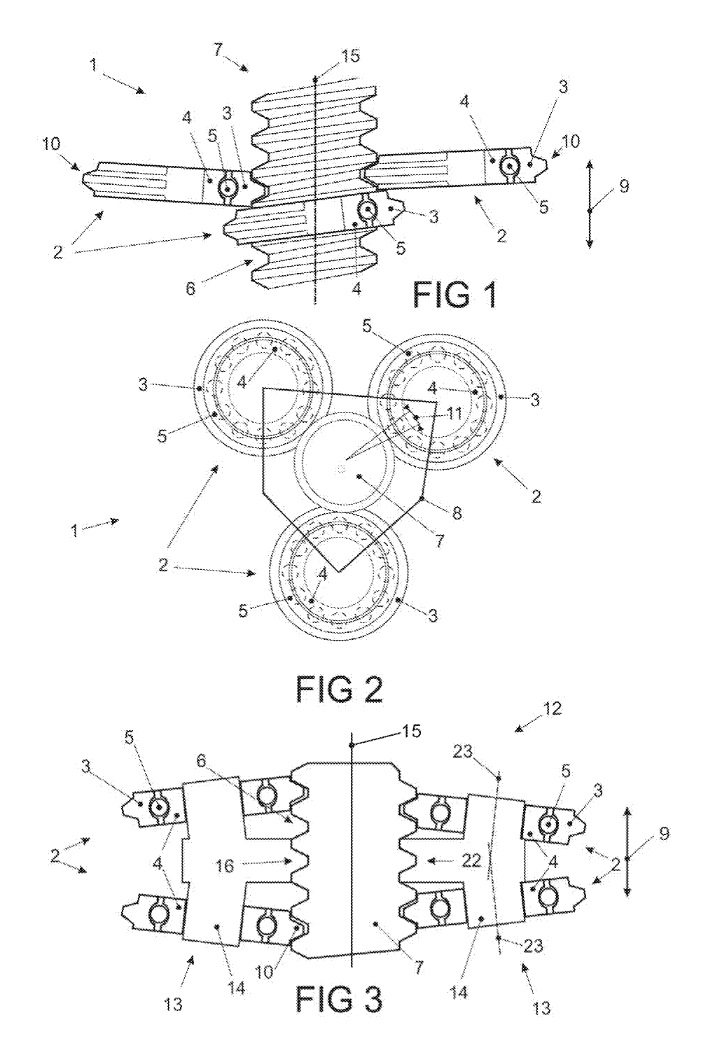

FIG. 1 shows a side-view of a screw drive 1 with three ball bearings 2, each of which has an outer ring 3, an inner ring 4 and balls 5 arranged between the outer ring 3 and the inner ring 4. The ball bearings 2 engage with their outer rings 3 in the thread 6 of a threaded spindle 7. The three ball bearings 2 each form a planet and are held together by a holder 8 symbolically shown in FIG. 2. The outer rings 3 of the ball bearings 2 have bars 10, which are adapted to the thread 6 of the threaded spindle 7 and unroll in it. Since the curvatures of thread 6 of threaded spindle 7 and web 10 of outer ring 3 are oriented differently, the outer ring 3 only engages in thread 6 via a relatively short angle section 11.

FIG. 2 shows the screw drive 1 from above, where two of the three ball bearings 2 are held at an angle of about 100 degrees to each other and are fixed at an angle of 130 degrees to the third ball bearing 2 in the holder 8. Depending on the application of the screw drive 1, an asymmetrical arrangement of the three ball bearings 2, in order to allow more load-bearing capacity (cross to the longitudinal axis 15 of the threaded rod 7) in a preferred direction, or a symmetrical arrangement of the ball bearings 2 offset by 120 degrees can be advantageous.

FIG. 3 shows a sectional drawing of a side-view of a thread drive 12 according to another example of the invention. The screw drive 12 has two groups 13 of two ball bearings 2 of each group 13, whereby the four ball bearings 2 with their outer rings 3 engage in the thread 6 of a threaded spindle 7. In this design example of the invention, one group 13 of two ball bearings 2 each forms a planet, whereby the two ball bearings 2 of a group 13 are connected to their inner rings 4 by a bearing holder 14. The ball bearings 2 of the two groups 13 with their outer rings 3 engage in the thread 6 of the threaded spindle 7 offset by about 180 degrees. Bearing holders 14 form parts of the holder not shown and are connected via it.

The two axes 23 of the ball bearing 2 of a group 13 are fixed in the bearing holder 14, tilted against each other, which results in a better guidance of the webs 10 in the thread 6 of the threaded spindle 7. In addition, there is a better introduction of the bearing capacity of the holder into the threaded spindle 7.

One bearing holder 14 now has a bridge 16 and the other bearing holder 14 has a groove 22, with which they engage in thread 6 of the threaded spindle 7. This results in better guidance of the holder during linear movement of the holder or threaded spindle 7 along a transport direction of 9.

As can be seen from the two design examples of screw drives 1 and 12 with webs 10 in the outer rings 3 of FIGS. 1 to 3, the brackets 8 holding the ball bearings 2 together can be built very short, which is why screw spindle 7 must be only slightly longer than the transport path parallel to the longitudinal axis 15 of screw spindle 7. The advantage of this is that, if the length of the threaded spindle 7 is limited, a particularly long transport path or adjustment path of the holder or threaded spindle 7 is possible.

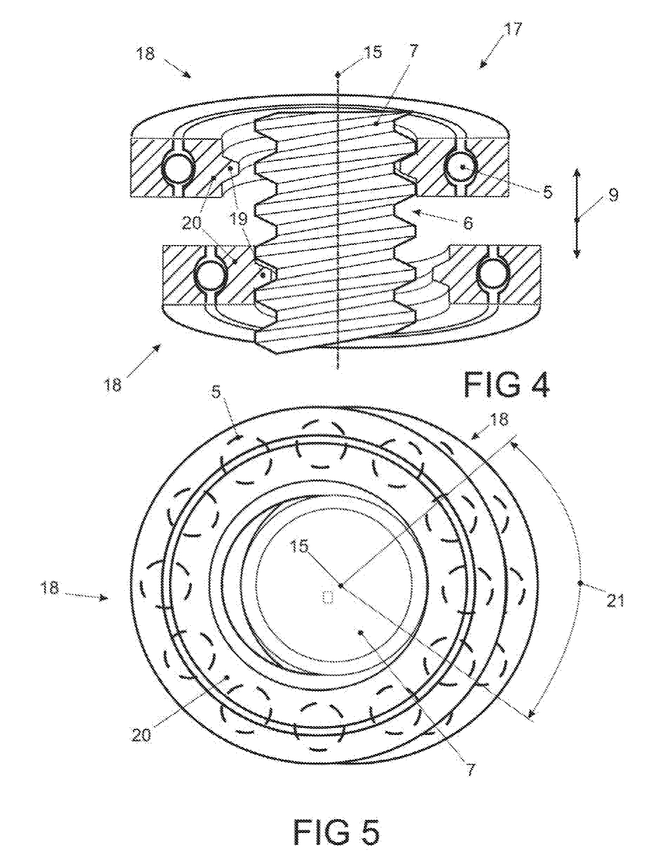

FIG. 4 shows a sectional drawing of a side view of a threaded drive 17 according to another example of the invention with two ball bearings 18, which engage with their bars 19 of the inner rings 20 in the thread 6 of the threaded spindle 7. In this design example of the invention, the ball bearings each form 18 planets, which with their inner rings engage in the thread 6 of the threaded spindle 7 with 20, each about 180 degrees offset in a holder not shown.

Since the bends of thread 6 of threaded spindle 7 and webs 19 of inner ring 20 are equally oriented, the inner ring 20 engages in thread 6 via a relatively large angular section 21 shown in FIG. 5. This ensures a very good power transmission and guidance of the holder. Furthermore, the advantage is that the two ball bearings 18, and thus also the entire mounting bracket, adhere to the threaded spindle 7, which is why the diameter of the mounting bracket is not much larger than the diameter of the threaded spindle 7. This thin design of the threaded drive 17 allows it to be used in areas where space is limited, such as lathes.

The axes of the ball bearings 18 are tilted to the longitudinal axis 15 of the threaded spindle 7, which is shown in FIG. 4 by the fact that of one ball bearing 18 the upper side is visible and of the other ball bearing 18 the lower side is visible. The ball bearings 18 are fixed at the pitch of the thread 6 of the threaded spindle 7, tilted and fixed in the holder. This achieves a particularly even running of the webs 19 in thread 6.

For all three of the above-mentioned design examples of screw drives 1, 12 and 17, it is possible that either the mounting bracket, which is marked with position number 4 in the design example of screw drive 1 and is not shown in the design examples of screw drive 12 and 17, is fixed in a non-rotating manner and that the screw spindle 7 is rotatable, or that the screw spindle 7 is fixed in a non-rotating manner and the mounting bracket is rotatable. In both cases, regardless of whether the threaded spindle 7 is fixed in a non-rotating manner or the holder is fixed in a non-rotating manner, either the threaded spindle 7 can be axially fixed and the holder can be moved along the transport direction 9 or the holder can be axially fixed and the threaded spindle 7 can be moved along the transport direction 9.

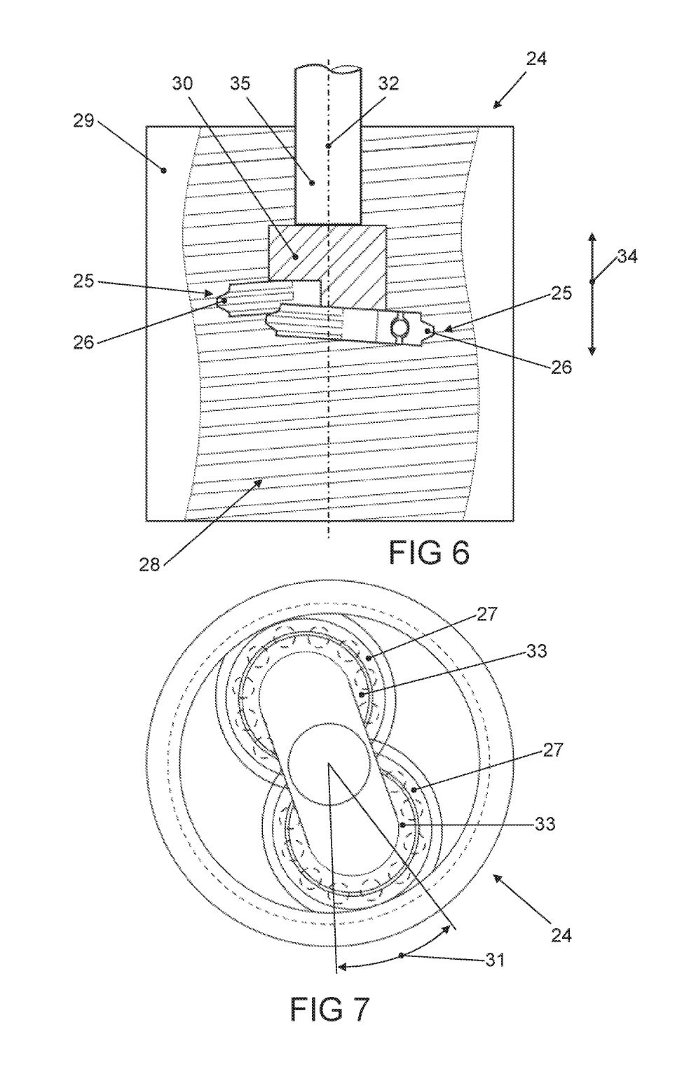

FIG. 6 shows a sectional drawing of a side view of a screwdriver 24 according to a further example of the invention with two ball bearings 25, which engage with their webs 26 of the outer rings 27 in the inner thread 28 of a hollow cylinder 29. In this design example of the invention, the ball bearings form 25 planets, each of which with its inner rings 33 engage in the female thread 28 of the hollow cylinder 29 at a 180-degree offset to the holder 30.

Since the curvatures of the inner thread 28 of the hollow cylinder 29 and the webs 26 of the outer ring 27 are oriented in the same direction, the outer ring 27 engages with the inner thread 28 via a relatively large angular section 31 shown in FIG. 7. This ensures a very good power transmission and guidance of the bracket 30.

The ball bearings 27 are fixed around the pitch of the internal thread 28 of the hollow cylinder 29 tilted at the holder 30. This results in a particularly smooth running of the webs 26 in the internal thread 28.

As can be seen from the design example of screw drive 24 with webs 26 in the outer rings 27 of FIGS. 6 to 7, the holder 30 holding the ball bearings 25 together can be built very short, which is why the hollow cylinder 29 must be only slightly longer than the transport path parallel to the longitudinal axis 32 of the hollow cylinder 29. The advantage of this is that, if the length of the hollow cylinder 29 is limited, it is possible to transport the holder 30 or the hollow cylinder 29 over a particularly long distance or to adjust it. The holder 30 is held by a cylinder 35 which protrudes from one end of the hollow cylinder 35. The cylinder 35 is designed to be as buckling resistant as possible. To increase the stiffness, two cylinders 35 can also be used to hold the holder 30, whereby one cylinder 35 is led out of each end of the hollow cylinder 35. Due to the design, very high forces can be transmitted because on the one hand the cover of the bearing outer rings 27 in thread 28 is very large and on the other hand the screw drive 24 has a greater safety against kinking compared to a threaded spindle due to the larger diameter. The advantage of this design is that the internal thread 28 of the hollow cylinder 29 is better protected from contamination than a thread of a threaded spindle and, with closed ends of the hollow cylinder 29, the screw drive 24 can also be used in environments that become soiled quickly and severely, such as drives in milling machines that are covered with chips.

As with the aforementioned examples, this design example of screw drive 24 also offers the possibility that either the holder 30 is fixed in such a way that it cannot rotate and the hollow cylinder 29 can be rotated, or that the hollow cylinder 29 is fixed in such a way that it cannot rotate and the holder 30 can be rotated. In both cases, regardless of whether the hollow cylinder 29 is fixed in a non-rotating manner or whether the holder 30 is fixed in a non-rotating manner, either the hollow cylinder 29 can be axially fixed and the holder 30 can be moved along a transport direction 34 or the holder 30 can be axially fixed and the hollow cylinder 29 can be moved along the transport direction 34.

It can be mentioned that different types of bearings can be used for screw drives according to the invention, such as different types and forms of rolling and/or plain bearings. Rolling bearings of the following types are particularly advantageous: ball bearings; tapered bearings; roller bearings.

It can be mentioned that screw drives according to the invention can have two, three, four or more bearings in a common holder. A larger number of bearings allows a higher load capacity of the screw drive. Furthermore, it would be possible to connect a bracket held by at least two bearings to another bracket held by at least two bearings on the same threaded spindle in order to achieve a wider support and increase the buckling stability.

It should be noted that grooves may be provided in both the outer rings and inner rings of the bearings which engage in the bar of the threaded spindle thread.

It can be mentioned that as a hollow cylinder with an internal thread, it is also possible to see any element that has a bore with an internal thread, and that therefore a hollow cylinder is not restricted to tubes.

1. A screw drive having an element having a thread, at least one planet and a holder, wherein the at least one planet is held by the holder and rolls off along a threaded portion of the thread of the element, and the holder; 30) is moving linearly along the thread of the element relative to the element, wherein the at least one planet is formed by a bearing which engages with its outer ring or with its inner ring in the thread of the element via an angular section.

2. The screw drive according to claim 1, wherein the element is designed as a threaded spindle or as a hollow cylinder having an internal thread.

3. The screw drive according to claim 1, wherein the outer ring or the inner ring engaging in the thread of the element engages in the thread via a groove and/or web in the outer ring or the inner ring of the element.

4. The screw drive according to claim 1, wherein the axis of the at least one planet is fixed in the holder tilted to the longitudinal axis of the element.

5. The screw drive according to claim 1, wherein the at least one planet has at least one further bearing and a group of bearings is formed thereby, the bearings of the group being connected by a bearing holder to their inner rings and engaging the thread of the element with their outer rings.

6. The screw drive according to claim 5, wherein the axes of the bearings of the group are fixed, tilted against each other, in the bearing holder.

7. The screw drive according to claim 5, wherein the bearing holders have a groove and/or a web with which they engage in the thread of the element.

8. The screw drive according to claim 1, wherein in the case of screw drives which comprise a plurality of planets, the planets are arranged at approximately equal angular spacings around or in the element and engage in the thread.

9. The screw drive according claim 1, wherein the bearings are formed by rolling bearings and/or by plain bearings.

10. The screw drive according to claim 4, wherein the axis of the at least one planet is fixed in the holder tilted substantially about the pitch of the thread to the longitudinal axis of the element.
